(19) United States
(12) Patent Application Publication
(10) Pub. No.: US 2010/0045721 A1
(43) Pub. Date: Feb. 25, 2010

(54) PRINT SMOOTHING METHOD

(75) Inventors: Martin Schaum, Oosduinkerke (BE); Gunter Caus, Oostende (BE); Serge Defever, Oudenburg (BE); Bruno Vierstraete, Koekelare (BE)

Correspondence Address: MERCHANT & GOULD PC, P.O. BOX 2903, MINNEAPOLIS, MN, 55402-0903, US

(73) Assignee: MUTOH EUROPE NV, Oostende (BE)

(21) Appl. No.: 12/440,580

(22) PCT Filed: Oct. 1, 2007
(86) PCT No.: PCT/EP07/60411

§ 371 Date: Aug. 13, 2009

Related U.S. Application Data
(60) Provisional application No. 60/848,849, filed on Oct. 2, 2006.

(30) Foreign Application Priority Data
Nov. 3, 2006 (EP) 06123487.8

(51) Int. Cl. B41J 29/38

(52) U.S. Cl. 347/14

(57) ABSTRACT

In dot matrix printing and use with a dot matrix printer, a first swath of ink dots is laid down during a first pass of a printing head. The first swath comprises a first zone (9) and a second zone (7, 8), extending along the entire length of the swath. The second zone extends from the first zone to an outer longitudinal border of the swath; which is not a straight line. The average concentration of ink dots in the second zone is arranged to be lower than the average concentration (1) of ink dots in the first zone. One or more additional swaths of ink dots are laid down during following passes of the printing head, which overlap the second zone of the first swath, thereby increasing the average concentration of ink dots in the second zone for obtaining a substantially equal concentration of ink dots in the first and second zones.

### FIELD OF THE INVENTION

The present invention is related to dot matrix printing methods and dot matrix printers. More particularly, the present invention is related to an ink jet printing method and ink jet printer preventing the occurrence of visible banding.

### STATE OF THE ART

High speed printing with ink jet printers is nowadays limited by the incapability of the used ink to dry fast enough. Furthermore, stepping mismatches (variations in paper feed steps) and miss-firing nozzles show up in the printed image via ink bleeding and various types of banding. These image defect phenomena show a repetitive pattern and/or a geometry which is easily recognizable by the human eye.

An ink jet printer has a printing head comprising a plurality of nozzles from where ink is fired onto a printable medium. The nozzles are generally ordered in one or more arrays. The printing head moves fast in a fast scanning direction, generally coinciding with the width of the printable medium. The printing head also moves relatively to the printable medium in a slow scanning direction, generally perpendicular to the fast scanning direction. Movement in the slow scanning direction occurs in discrete steps, i.e. after a fast scan, the printing head moves relatively to the printable medium in the slow scanning direction towards a consecutive position after which a fast scan may be executed. A fast scan is generally referred to as a pass. Ink may be fired from the nozzles during a pass. Ink fired repetitively from one nozzle during a pass, appears on the printable medium along a line. This line is called a raster line.

On a traditional dot matrix printer, a family of printers to which an ink jet printer belongs, an image is recorded (formed) on a printable medium by printing a series of complementary rectangularly shaped stripes (also called bands, passes or swaths). These rectangular stripes are printed adjacent to each other, or may even overlap to a certain degree. In the overlap portion of a pass, raster lines in between existing raster lines are printed so as to increase the resolution of the printed image.

If the previously printed swath is still wet, there is a flow of the ink from the last printed swath to the previous one (referred to as ink bleeding). This flow creates a region in the last printed swath, adjacent to the previously printed swath, with a low ink concentration, and a region in the previously printed swath with a high ink concentration. The result is the occurrence of clearly visible stripes in the print, also called banding. Furthermore, the adjacent swath printing technique needs an exact step-adjust. When two swaths overlap the ink concentration in the overlapped zone increases and also causes banding. In case of a spacing between two adjacent swaths, this gap is also clearly visible.

Ink jet printing equipment manufacturers have put forward a number of dot printing strategies in order to overcome the phenomenon of banding. Patent application US 2003/202215 discloses to use a shingle mask derived from a shingle mask density distribution which exhibits a substantially trapezoidal shape. The accumulated shingle mask density distribution has a substantially smooth decreasing portion, which reduces the number of drops to be printed along the outermost edges of the mask on each swath.

U.S. Pat. No. 6,357,847 discloses a method for stitching print swaths. The edges of the swaths are dithered to vary the depth of cut in accordance with the expected paper advance accuracy. The dithering process scatters the edge from a single line into a multitude of widely separated pixels dispersed throughout the overlap region.

With these prior art methods some degree of banding can still be visible. The banding that occurs in the prior art methods of printing, occurs mostly along straight lines parallel to the fast scan direction (because of faults in the slow scan direction, which is perpendicular to the fast scan direction). Therefore, if the banding errors are repetitive of nature (e.g. repeated in each pass), they form a kind of pattern, which is very likely to still be discerned by the human eye.

### AIMS OF THE INVENTION

The present invention aims to provide an improved dot matrix printing method that further reduces visible banding in images, while retaining high printing speeds, thereby overcoming the drawbacks of prior art methods. The present invention equally aims to provide an apparatus implementing said method.

### SUMMARY OF THE INVENTION

The present invention is related to dot matrix printing methods and apparatuses, as set out in the appended claims, which reduce the occurrence of visible banding. The banding errors in a print out of the prior art remain discernible to the human eye because (i) they are mostly of a repetitive nature and (ii) they all occur along parallel, straight lines (“banding lines”). The human eye is very sensitive to even the smallest pattern of intensity variation occurring in a print out along one and a same direction (i.e. along parallel lines). Therefore, the prior art methods to reduce visible banding by reducing the ink density at the swath borders still can lead to the banding causing stripes of slight ink intensity variation which are visible.

The present invention solves the above problem by “breaking” the continuity of the banding lines or stripes. As a result, the banding lines are not straight any more and the banding pattern is less visible to the human eye.

Therefore, according to a first aspect of the invention, there is provided a method of dot matrix printing an image, the method comprising the step of laying down on a printable medium a first swath of ink dots, during a first pass of a printing head, said dots representing a portion of print data of the image, wherein:
said first swath comprises a first (central) zone and a second (peripheral) zone,
said first and second zones extend along the entire length of the swath,
said second zone extends from the first zone to an outer longitudinal border of the swath,
said outer longitudinal border has the shape according to a function or pattern and
the average concentration of ink dots in the second zone is arranged to be lower than the average concentration of ink dots in the first zone.
   The method further comprises the step of laying down on the printable medium one or more additional swaths of ink dots during following passes of the printing head, said one or more additional swaths overlapping at least (fully or partially) the second zone of the first swath, thereby increasing the average concentration of ink dots in at least said second zone in order to obtain a substantially equal concentration of ink dots in said first and second zones.

The shape of said outer longitudinal border is not a straight line. The shape of said outer longitudinal border can be according to a (mathematical) function. A function refers to the graphical representation of said (mathematical) function as a line or curve. Said shape can be according to a pattern as well. The pattern is preferably repeated along said outer longitudinal border.

The pattern or function is preferably a waveform. A waveform refers to the shape of a linepiece, which is not straight, and which is repeated along a direction of propagation. Preferably, the waveform is a sine. More preferably, the waveform is a superposition of sines (Fourier series). Equally preferably, the waveform is a triangle wave.

Said substantially equal concentration is interpreted in view of the print data, in that the total concentration of ink dots laid down by the different swaths must coincide with the concentration as defined in the print data of the image.

The print data has preferably the same resolution as the printing head. The print data can be a subset of print data of the image, said subset preferably having the same resolution as the printing head.

Preferably, said one or more additional swaths each comprise a first zone and a second zone having the same characteristics as respectively the first zone and second zone defined above. Preferably, at least the second zones of said one or more additional swaths overlap the first swath.

Preferably, the concentration of ink dots in the second zone gradually decreases from the border with the first zone towards the longitudinal border of the swath. More preferably, the method of the invention comprises the step of applying a dithering filter for obtaining the gradual decrease of concentration of ink dots.

Preferably, the concentration of ink dots in the second zone comprises a gradient of decreasing concentration from the border with the first zone towards the longitudinal border of the swath. More preferably, the method of the invention comprises the step of applying a dithering filter for obtaining said gradient.

Preferably, the outer longitudinal border of the swath (forming a border of the second zone) is arranged to be blurred.

Preferably, the outer longitudinal border of the swath comprising a repeating pattern follows the shape of a waveform. More preferably, said waveform is a sine.

Preferably, the method of the invention comprises the consecutive steps of:
applying a mask to a first portion of the print data of the image,
recording only the unmasked print data of said first portion of print data, thereby recording a first swath,
subtracting the unmasked data from the print data after the recording step,
applying said mask to a second portion of the print data, partially overlapping the first portion and
recording only the unmasked print data of said second portion of print data, thereby recording a second swath.

More preferably, the mask comprises a first portion in which all bits are unmasked and a second portion comprising masked bits. In the second portion, the masked bits are arranged to let the ink concentration degrade gradually towards a border of the mask.

More preferably, said print data comprises data related to multiple colour channels. Preferably, in said step of applying a mask, a different mask is applied to each of the print data related to a different colour channel.

Preferably, the method comprises the steps of: dividing the print data into complementary subsets of print data, each of said subsets having a resolution equal to the resolution of the printing head and interleaving the printing of said subsets of print data.

According to a second aspect of the invention, there is provided an apparatus for dot matrix printing comprising:
means for receiving print data,
a printing head supplied with ink for recording the print data on a printable medium in the form of ink dots, the printing head arranged for performing a fast scan over the printable medium in a first direction and a slow scan over the printing medium in a second direction, whereby the printing head records the print data in partially overlapping swaths, said swaths extending along the first direction and
means for carrying out the method according to the invention.

Preferably, said means for carrying out the method according to the invention are arranged for applying a mask stepwise to the print data.

Preferably, the apparatus of the invention is arranged for printing multiple colour channels. More preferably, the apparatus is arranged for applying a different mask for each of the colour channels.

### BRIEF DESCRIPTION OF THE DRAWINGS

FIG. 1 represents the maximal ink concentration in a cross-sectioned swath.

FIG. 2 represents the maximal ink concentration of adjacent, overlapping swaths.

FIG. 3 represents the maximal ink concentration when ink bleeding phenomena occur at the border between two adjacent swaths.

FIG. 4 represents how to smooth ink bleeding by overlap of different swaths.

FIG. 5 represents swath borders having a wave-like shape, with and without smoothing function applied.

FIG. 6 represents an implementation of print smoothing according to the invention by application of a bitmap mask on the print data.

FIGS. 7 and 8 represent cases where parts of the image are smooth filtered more than once or not filtered at all.

FIG. 9 represents an implementation of print smoothing and swath shaping according to the invention by application of a bitmap mask on the print data.

FIG. 10 represents a print swath according to the invention having longitudinal borders of sinusoidal shape.

### DETAILED DESCRIPTION OF THE INVENTION

The invention can minimize the occurrence of banding phenomena and can further visibly enhance the print quality by application of a swath shaping method and a smoothing filter.

The invention proposes to apply a swath shaping printing method in combination with a smoothing filter. In the swath shaping method, the longitudinal borders of a swath have the shape of a repeating pattern (not a straight line, e.g. a sinus). Should banding occur, than it is less recognizable for the human eye.

The shaping of the longitudinal border(s) of the swath is combined with a smoothing filtering of a border region of the swath in order to provide prints free of visible banding. The border region—a zone of the swath, lying adjacent to the longitudinal border (edge)—is printed at less than full (final) intensity. That border region is overlapped by one or more following swaths in order to achieve the final intensity of ink in said border region. Hence, the invention provides for applying a smoothing filter to said zone (or border region) in order to render the transition between two consecutive swaths smooth.

The length of a swath is the dimension along the fast scan direction (or the dimension along the direction of a pass of the printing head). The breadth of a swath is the dimension along the slow scan direction.

The swath shaping method, used in combination with the smoothing filter of the invention, results in the overlapped zone being no longer rectangular, but following the shape of the swath's border.

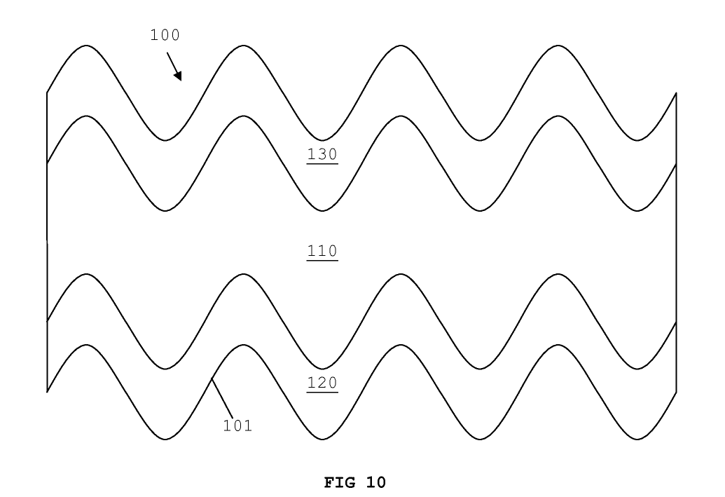

In the swath shaping technique, the longitudinal border of a swath assumes a particular shape, as e.g. represented in FIGS. 5 and 10. The shape 50 and 101 can be according to any function (e.g. sine), and is preferably a repetitive function or pattern.

The function or pattern is preferably a waveform. Examples of waveforms are sines, triangular waveforms, sawtooth waveforms and any combination of these. The function or pattern is preferably a sine or a combination of sines. Preferably, it is a Fourier series. The function or pattern is preferably also a triangular waveform. The waveform can also be a modified sine or triangular wave. The slope of the latter waves can then be made convex or concave.

Both the upstream and downstream longitudinal border of a swath can have the shape of a repeating pattern, preferably a waveform. The upstream and downstream longitudinal border of a swath can have the shape of different repeating patterns (different waveforms).

According to a preferred embodiment of the method, consecutive swaths have longitudinal borders with different shape (i.e. according to a different function or pattern).

The amplitude of the function or pattern (e.g. the waveform) is preferably at least 10 pixels. The amplitude is measured along the slow scan direction (direction of the breadth of the swath).

Any banding that may occur, does not follow a straight line, but follows the shape 50 of the border, which is less easily recognized by the human eye.

FIG. 5 shows examples of swath borders according to only the swath shaping technique (without the smoothing filter) and to the swath shaping technique with smoothing filter applied. The smoothing filter actually blurs the swath's border. This blurred border, combined with the overlapping of adjacent swaths makes visible banding less likely to occur.

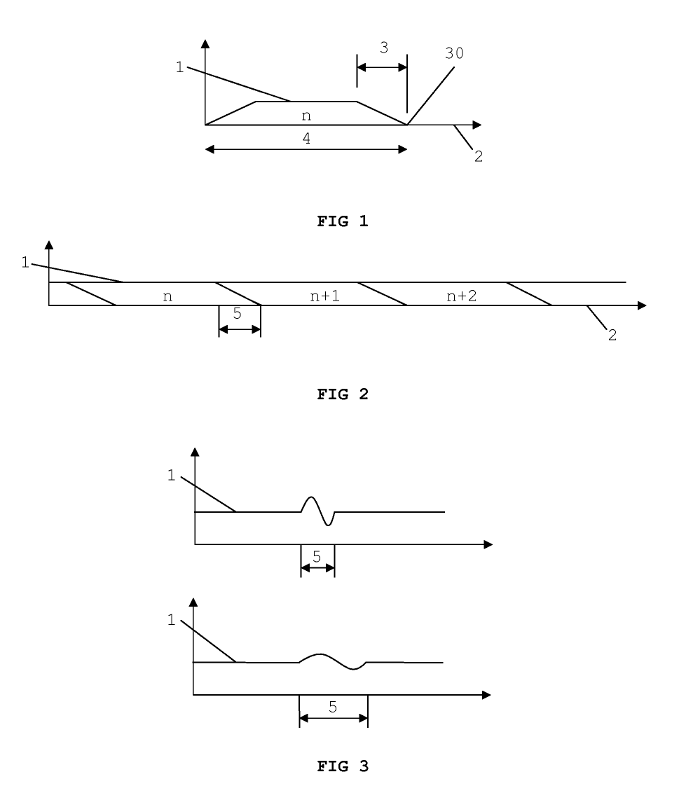

The smoothing filter works as follows. FIG. 1 represents the ink concentration 1 (or ink density) that can maximally be deposited in one pass (maximal ink concentration) versus the slow scan direction 2. In order 5 to reduce the negative side effects of the long ink drying time, a portion 3 of a swath 4 is printed with decreased ink concentration. The portion 3 of the swath may be adjustable in size. The ink concentration within this portion can decrease gradually to zero, where zero concentration is achieved at the border 30 of the swath. By printing adjacent swaths with an overlap 5 equal to the size of the portion 3 of decreased ink concentration, a uniform maximal ink concentration can be achieved in the ideal case of no ink bleeding and good step adjust, as represented in FIG. 2. The adjacent swaths n, n+1, n+2 . . . overlap by an amount equal to the portion 3 of decreased ink concentration.

As shown in the upper graph of FIG. 3, in reality, due to ink bleeding the ink concentration 1 is not constant in the overlap region 5, but rather follows the indicated profile. However, the profile of the concentration smoothens when the amount of overlap 5 is enlarged—and hence also the size of portion 3 is enlarged. This is shown in the lower graph of FIG. 3.

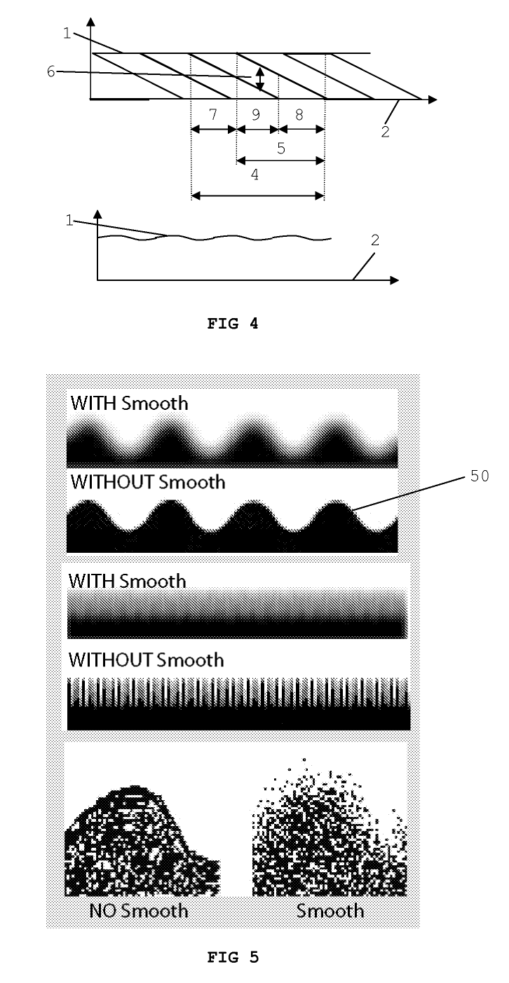

When the overlap 5 is equal to half the width 4 of a swath, one half of the swath overlaps the preceding swath, and another half of the swath is overlapped by the subsequent swath. The amount of overlap 5 may be larger than half the width 4 of a swath, in which case a portion of the swath is overlapped by more than one other swath, as shown in FIG. 4. This allows to smoothen the ink concentration profile 1 even more. The amount of overlap 5 should be chosen in function of the drying characteristics of the ink and of the kind of printable medium (e.g. type of paper). The profile of the ink concentration in the overlap region 3 may have any shape, as long as the superposed profiles of the overlapping swaths equal the final ink concentration.

The final ink concentration is defined as the ink concentration in the case of no smoothing and no overlap, such that all ink would have to be deposited in one, not smoothed swath.

The example of FIG. 4 shows the case in which two or more overlapping swaths are needed in order to arrive at the final ink concentration. In other words, the overlapped zone 5 (see also zone 5 in FIG. 2) is more than half a band and none of the swaths comprises a no-overlap zone. Referring to FIG. 4, each swath has one or more (peripheral) zones 7 and 8 in which the ink concentration is lower than the ink concentration in another (central) zone 9. In the particular case of FIG. 4, the latter, central zone 9 shows a constant ink concentration 6, being the maximal ink concentration of the swath (which is deposited in one pass). However, depending on the ink concentration profile in an overlap zone, the ink concentration is not necessarily constant within such a central zone. Central and peripheral zones do not necessarily coincide with overlap and no-overlap zones.

FIG. 10 represents a swath 100 having longitudinal borders 101 of sinusoidal shape. A first or central zone 110 of the swath is located centrally and extends along the entire length of the swath. Second or peripheral zones 120 and 130 are located at a border, between the first zone 110 and a longitudinal border 101 of the swath. They extend along the entire length of the swath as well. At least the second zones 120 and 130 are overlapping zones, which can overlap with an adjacent swath.

The method of the invention provides for applying a smoothing filter (at least) in the second zones 120 and 130. In the step of printing the swath 100. The concentration of ink drops (the ink density) in the second 5 zones is arranged to be lower on average with reference to the first zone 110. According to a preferred embodiment, the concentration of ink drops in the second zones decreases gradually from the first, central zone 110 towards the longitudinal border 101 of the swath.

Dithering methods can be applied as smoothing filter. Dithering methods (filters) can apply a gradient to the decrease of the concentration of ink drops (dots) towards the longitudinal border of the swath. The application of a dithering method or other smoothing filter can render the edge or border of the swath blurred or fuzzy.

The application of the smoothing filter of the invention has 3 major advantages:
zones of high ink concentration of the actual swath never touch zones of high ink concentration of a previous swath,
the banding created by a wrong step adjust is averaged over the whole overlapped zone,
if the width of the overlap is larger than half the width of a swath, the maximal ink concentration per swath can be controlled by adjusting the size of the overlapped zone.

The combination of smoothing and swath shaping proves to be particularly effective when the size of the overlapped zone is smaller than half the width of the swath.

### Description of a Preferred Embodiment of the Invention

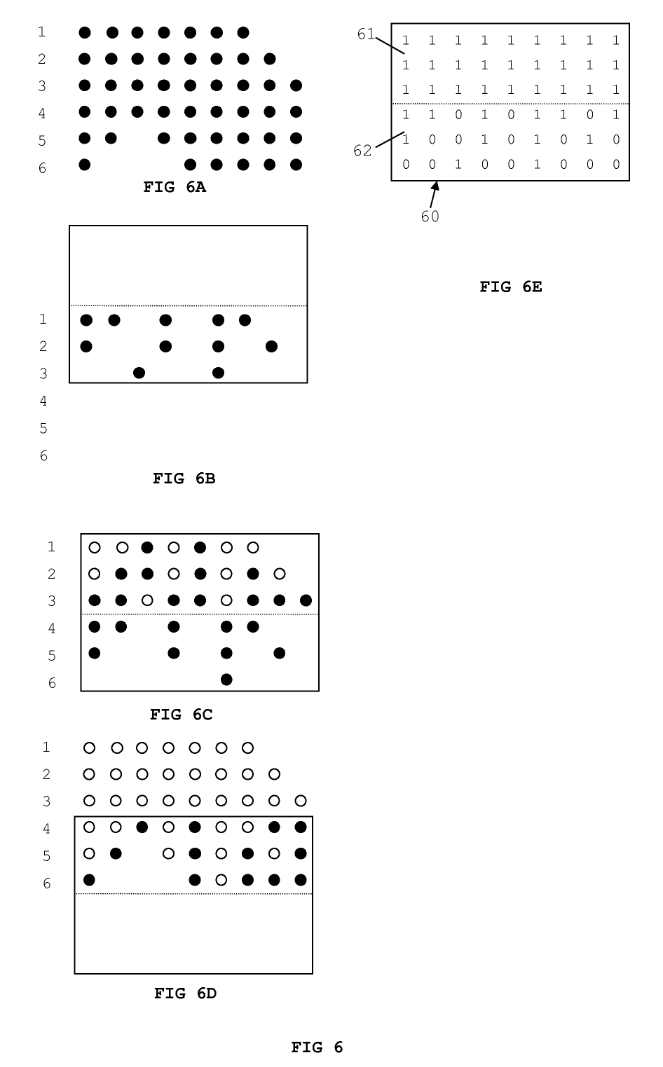

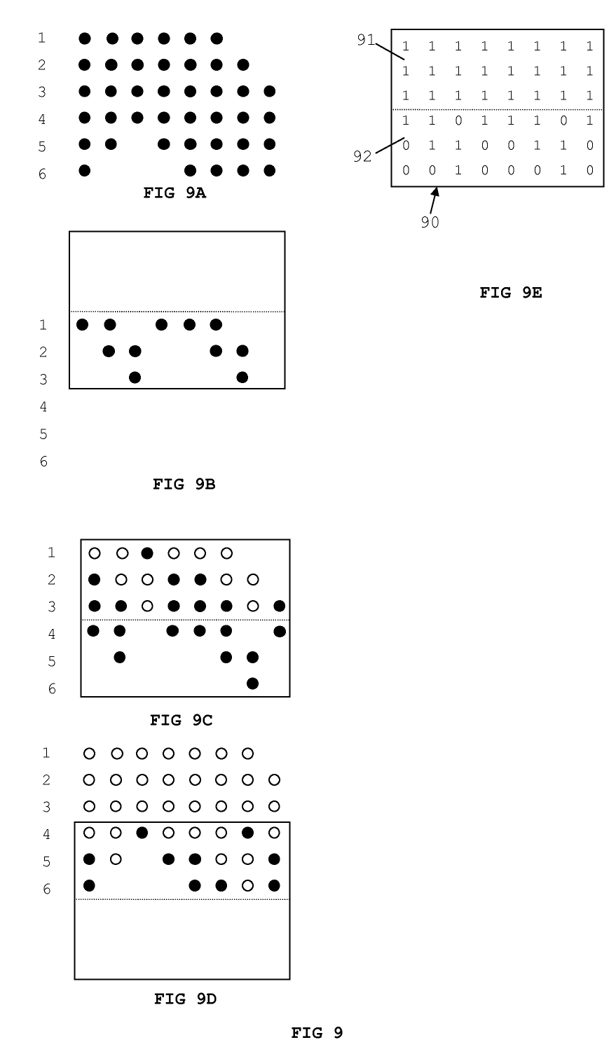

The invention can be implemented as follows. For each colour channel (e.g. cyan, magenta, yellow and black) a monochrome bitmap mask is set up. The bitmap mask represents all possible dots of one colour that can be recorded in one swath. Hence, the mask has the size of a swath. Each dot is represented by a bit. Bits set in this mask represent dots that may be recorded, not set bits represent dots that may not be recorded. There can be one bitmap mask for each colour channel of a swath. FIGS. 6E and 9E represent examples of a layout of a bitmap mask 60.

The bitmap mask is divided in two zones, extending along the entire length of the swath (the longitudinal direction of a swath coincides with the fast scan direction): a first zone 61 in which all bits are set (no-filter zone) and a second zone 62 in which some bits are not set (smoothing filter zone). In this context, a bit set as “1” is an unmasking bit, while a bit that is not set is a masking bit. The choice of which bits not to set depends on the selected smoothing profile. The minimal breadth of the no-filter zone is 1 dot. Filter and no-filter zones do not necessarily coincide with central and peripheral zones.

The set of masks is subsequently applied to the print data. The print data corresponding to a determined colour channel is masked with its corresponding bitmap mask. A bitwise logical “AND” operation is carried out between corresponding bits of print data and bitmap mask. Hence, for the bits that are not set (the masked bits) in the bitmap mask, no dot is recorded. Bits that are not set in the print data are not recorded, no matter whether the corresponding bit in the bitmap mask is set or not.

After having recorded one swath, the effectively recorded dots are subtracted from the print data, leaving the dots that still are to be recorded. Subsequently, the set of masks is shifted in slow scan direction over the print data by the breadth of the no-filter zone and the bitmap mask is applied to those lines of print data, resulting in the data that will be recorded in a subsequent swath. The printing head equally performs one slow scan relatively to the printable medium, after which the subsequent swath can be recorded according to the method set out above. Hence, each colour channel in the print data is masked with the corresponding bitmap mask and dots corresponding with set bits are recorded.

The swath shaping pattern can be integrated in the bitmap mask. In this case and without a smoothing filter applied, unmasked bits define a swath with a swath shaping pattern (e.g. having wave-like borders as in FIG. 5). A smoothing filter is then superposed on the swath shaping pattern. The smoothing filter zone of the bitmap mask may either be defined as a rectangular zone comprising the swath shaping pattern, or as a zone having a border of the same shape as the swath shaping pattern.

The smoothing filter method is represented in a simplified manner in FIGS. 6 and 9. FIG. 6A represents an image that is to be printed, by recording a number of dots on a printable medium. The print data comprises six lines and only one colour channel (black). In FIG. 6, the image of FIG. 6A will be printed according to a smoothing filter method of the invention, by application of the bitmap mask 60 of FIG. 6E. Bitmap mask 60 comprises a no-filter zone 61 (91 in FIG. 9), in which all bits are unmasked, and a zone 62 (92 in FIG. 9) in which a smoothing filter is implemented, resulting in masked and unmasked bits. The smoothing filter in zone 62 (92 in FIG. 9) lets the ink concentration degrade gradually towards the border of the mask. Hence, the recording of a first swath is represented in FIG. 6B. In FIG. 6B, only zone 62 of mask 60 is applied to the print data. Only the dots for which corresponding bits in bitmap mask 60 are set are recorded. The first three lines of the print data are only partially recorded, in accordance with the smoothing filter zone 62 of bitmap mask 60. The method subsequently proceeds to the printing of the next swath. Hence, the bitmap mask is shifted by an amount equal to the breadth of the no-filter zone 61, i.e. 3 lines. The recording of the second swath is represented in FIG. 6C. The empty dots represent those that have been recorded in the previous swath. The filled black dots are recorded in the present swath. The no-filter zone 61 now covers line 1 to 3 of the print data. The dots in line 1 to 3 that were not recorded in the previous swath because of the smoothing filter, are now all recorded (filled black dots). In the third swath, represented in FIG. 6D, the bitmap mask is further shifted three lines. The no-filter zone 61 now covers line 4 to 6 of the print data. As can be seen from the figure, the dots that were not recorded in the previous swath because of the smoothing filter, are now all recorded (filled black dots).

For FIGS. 9A-E, the explanation is analogous to FIGS. 6A-E respectively.

FIGS. 6 and 9 represent two different swath shaping patterns. In the bitmap 90 of FIG. 9, the swath shaping pattern is repeated twice, while in the bitmap 60 of FIG. 6, the pattern develops along the entire length thereof. In practice, the bitmaps are of larger length and the pattern of FIG. 6 can be repeated several times.

In practice, the size of the bitmap mask is much larger than the mask in the example of FIG. 6 or 9. In such large masks the bits in the smoothing filter zone may be masked according to any desired type of smoothing filter in order to gradually decrease the ink concentration towards the border of the mask (and hence, the border of the swath).

When the resolution of the print data is higher than the resolution of the printing head, the print smoothing method described above can still be applied. In the latter case, the print data is split into complementary subsets of print data, all having the same resolution as the printing head. These subsets overlap. The print smoothing method is applied to each of the above subsets of print data separately. Hence, consecutive swaths may not belong to the same subset of print data.

The breadth of the no-filter zone determines the slow scan step size. The breadths of the smoothing filter zone and the no-filter zone also determine the intensity of filtering of the print data. When the breadth of the smoothing filter zone is smaller than the breadth of the no-filter zone, portions of the print data will not be filtered. When the breadth of the smoothing filter zone is much larger than the breadth of the no-filter zone, the print data is filtered more than once. The more times the printing data is filtered the less ink is used per swath. By so doing an optimal balance between speed and quality may be determined.

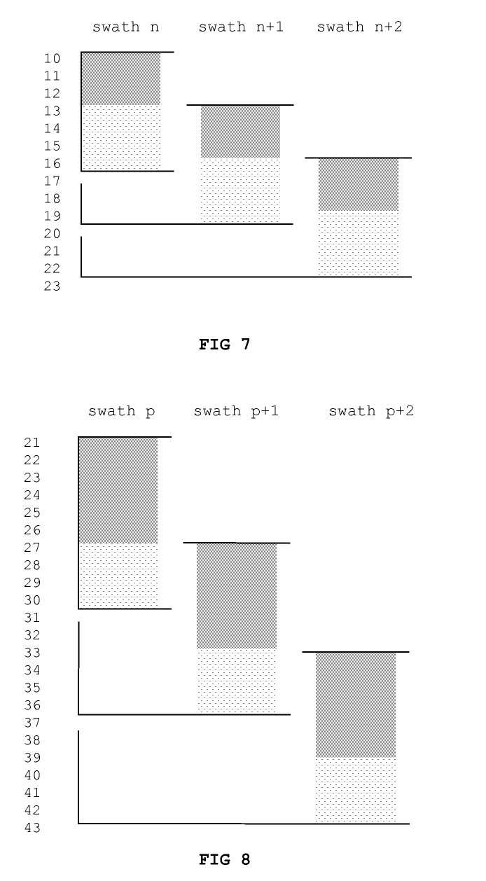

It is important to note that, depending on the breadths of the smoothing filter zone and the no-filter zone, not every portion of the print data may be filtered the same number of times. This is illustrated in FIGS. 7 and 8. FIG. 7 represents the case where the breadth of the no-filter zone is smaller than the breadth of the smoothing filter zone. In the particular example of FIG. 7, the no-filter zone extends over 3 lines (e.g. lines 10-12 for swath n) and the smoothing filter zone extends over 4 lines (e.g. lines 13-16 for swath n). For the recording of the subsequent swath n+1, the printing head moves over a distance equal to the breadth of the no-filter zone (three lines in the present example). As the smoothing filter zone is larger than the no-filter zone, a portion of the print data is filtered twice. In the example of FIG. 7, the print data of line 16 is filtered in swath n and also in the consecutive swath n+1. FIG. 8 represents the case in which the breadth of the no-filter zone is larger than the breadth of the smoothing filter zone. In the particular example of FIG. 8, the no-filter zone extends over 6 lines (e.g. lines 21-26 for swath p) and the smoothing filter zone extends over 4 lines (e.g. lines 27-30 for swath p). For the recording of the subsequent swath p+1, the printing head moves over a distance equal to the breadth of the no-filter zone (six lines in the present example). As the smoothing filter zone is smaller than the no-filter zone, a portion of the print data is not filtered. In the example of FIG. 8, the print data of lines 31 and 32 is not filtered.

For most print resolutions it is sufficient to use the same bitmap mask for all colour channels. Depending on the scan speed, the type of printable medium, the amount of ink fired per nozzle and other factors, a finer gradient of the ink concentration is needed. In this case each colour channel may get a different bitmap mask.

One restriction can be that the breadth of the no-filter zone has to be the same in all bitmaps of the set, as this breadth determines the slow scan step size. The overall smoothing is determined by the sum of all bitmaps of the set of masks. The set of masks can be designed according to particular needs, as long as the size of the no-filter zone is the same for all bitmap masks.

According to another embodiment, the breadth of the no-filter zone can differ between the bitmaps of the colour channels. The slow scan step size can be determined by the smallest breadth of no-filter zone.

1. A method of dot matrix printing an image, the method comprising:
laying down on a printable medium a first swath of ink dots, during a first pass of a printing head, said dots representing a portion of print data of the image, wherein:
said first swath comprises a first zone and a second zone,
said first and second zones extend along the entire length of the swath,
said second zone extends from the first zone to an outer longitudinal border of the swath,
said outer longitudinal border has the shape according to a function or pattern without being a straight line and
the average concentration of ink dots in the second zone is arranged to be lower than the average concentration of ink dots in the first zone.
laying down on the printable medium one or more additional swaths of ink dots during following passes of the printing head, said one or more additional swaths overlapping the second zone of the first swath, thereby increasing to increase the average concentration of ink dots in said second zone in order to obtain a substantially equal concentration of ink dots in said first and second zones.

2. The method according to claim 1, wherein the pattern is repeated along the outer longitudinal border.

3. The method according to claim 1, wherein the function or pattern is a waveform.

4. The method according to claim 3, wherein said waveform is a sine.

5. The method according to claim 1, wherein the concentration of ink dots in the second zone gradually decreases from the border with the first zone towards the outer longitudinal border of the swath.

6. The method according to claim 5, comprising the step of applying a dithering filter for obtaining the gradual decrease of concentration of ink dots.

7. The method according to claim 5, wherein the outer longitudinal border of the swath is arranged to be blurred.

8. The method according to claim 1, wherein:
said one or more additional swaths each comprise a first zone and a second zone as respectively the first zone and second zone defined in claim 1, and
the second zones of said one or more additional swaths overlap the first swath.

9. The method according to claim 1, comprising the consecutive steps of:
applying a mask to a first portion of the print data of the image,
recording only the unmasked print data of said first portion of print data, thereby recording a first swath,
subtracting the unmasked data from the print data after the recording step,
applying said mask to a second portion of the print data, partially overlapping the first portion, and
recording only the unmasked print data of said second portion of print data, thereby recording a second swath.

10. The method according to claim 9, wherein said print data comprises data related to multiple color channels and wherein in said step of applying a mask, a different mask is applied to each of the print data related to a different color channel.

11. An apparatus for dot matrix printing comprising:
means for receiving print data,
a printing head supplied with ink for recording the print data on a printable medium in the form of ink dots, the printing head arranged for performing a fast scan over the printable medium in a first direction and a slow scan over the printing medium in a second direction, whereby the printing head records the print data in partially overlapping swaths, said swaths extending along the first direction and
means for carrying out the method according to claim 1.

12-13. (canceled)

14. An apparatus for dot matrix printing comprising:
means for receiving print data,
a printing head supplied with ink for recording the print data on a printable medium in the form of ink dots, the printing head arranged for performing a fast scan over the printable medium in a first direction and a slow scan over the printing medium in a second direction, whereby the printing head records the print data in partially overlapping swaths, said swaths extending along the first direction and
means for carrying out the method according to claim 1 arranged for applying a mask stepwise to the print data.

15. The apparatus according to claim 14, for printing multiple color channels and arranged for applying a different mask for each of the color channels.
